(19) United States
(12) Patent Application Publication
(10) Pub. No.: US 2012/0247682 A1
(43) Pub. Date: Oct. 4, 2012

(54) Labeling Machine for Conical Containers with Titled Transfer Mechanism

(75) Inventor: Dieter Leykamm, Neutraubling (DE)

(73) Assignee: KRONES AG, Neutraubling (DE)

(21) Appl. No.: 13/422,254

(22) Filed: Mar. 16, 2012

(30) Foreign Application Priority Data
Mar. 18, 2011 (DE) 10 2011 005 784.6

(51) Int. Cl. B65C 3/00

(52) U.S. Cl. 156/556

(57) ABSTRACT

A labeling machine for conical containers with a container's axis of rotation, with a container directing device, a label transfer mechanism adjacent to the container directing device, and a label magazine embodied for dispensing labels to a label transfer means acting between the containers and the label magazine. The labeling machine includes a transfer mechanism having at least one rotating transfer cylinder rotating about a first axis of rotation, which is inclined relative to the container's axis of rotation. The label transfer means also has a transport pallet mechanism rotatable about a second axis of rotation and designed for withdrawing labels from the label magazine using vacuum, and at least one glue sprayer for dispensing glue cooperates with a label located on a transfer cylinder, such that a final gluing and/or an initial gluing is applied to the label.

### CROSS-REFERENCE TO RELATED APPLICATION

The present application claims the benefit of priority of German Application No. 102011005784.6, filed Mar. 18, 2011. The entire text of the priority application is incorporated herein by reference in its entirety.

### FIELD OF THE DISCLOSURE

The disclosure relates to a labeling machine for conical containers with a container's axis of rotation.

### BACKGROUND

Labeling machines are basically known from prior art, for example from DE 4409952 C1, DE 1902437 U, DE 2415919 A, U.S. Pat. No. 4,066,808, U.S. Pat. No. 4,242,168, JP 59-174434 A, JP 50-027798 U, DE 19741476 C5, DE 2642046 A1 and DE 102006012400 U1.

The labeling machine is embodied for labeling conically shaped containers, such as plastic cups, where these containers can be either empty or filled.

A similar labeling machine is known, for example, from U.S. Pat. No. 4,443,285. This patent specification discloses a labeling machine in which containers are moved in a container directing device. The container directing device in sections follows a circular contour. In the region of a gluing unit and a label application unit, the container directing device directs the containers from a first level to a second level. In the device known from this prior art, the labels are withdrawn from a label magazine, slightly coated with glue and transferred onto the container's surface by rolling off the containers on the labels.

Further devices are also known from prior art, for example from EP 0135935 B1.

For example, labeling machines are on the market today for which a plurality of labels is provided via a magazine. These labels are applied onto individual pallets of a pallet carousel. Such a pallet carousel can also be referred to as transport pallet mechanism.

Previously, special glue is applied onto the pallets so that the labels adhere to the pallets, when they are accepted from the magazine, exclusively by the adhesive effect of the glue applied onto the pallets. The pallet carousel then rotates the respective pallet away from the magazine into a dispensing position in which the label is then mechanically taken from a triple cylinder via gripper fingers. In the process, the label is quasi reversed, so that the fixing side provided with glue faces radially outwards with respect to the gripper cylinder. The gripper cylinder then rolls the label with its fixing side onto a passing object to be labeled, the label keeps adhered to the object to be labeled, that means the container, due to the adhesive effect of the glue.

Although the labeling machine briefly described above is widely spread for a fairly long time and is still well accepted due to its ruggedness, it showed that in particular the application of glue onto the pallets before labels are accepted from the magazine leads to a relatively high consumption of glue. This is in particular also due to the fact that at any one time a sufficiently large amount of glue has to be applied onto the pallets to ensure that the labels can be securely taken from the magazine by the adhesive effect of the glue. On the other hand, the application of such a relatively large amount of glue onto the pallets results in a considerable proportion of consumed glue getting lost during the application onto the pallets, for example by dripping off. Thus, cumbersome cleaning of these machines is required at regular intervals, in particular if such labeling machines are employed in the field of the food industry, such as beverage handling. The cleansing agents used for cleaning, however, attack individual machine components, such as seals, in the long run. Moreover, a considerable proportion of glue remains adhered to the pallets and is not taken along by the label accepted by the gripper cylinder. This also essentially increases glue consumption. The high glue consumption and the involved considerable cleaning requirement considerably affects the efficiency of these machines, in particular with high throughputs, for example in the beverage industry.

It is furthermore known from prior art to withdraw individual labels from a magazine by means of a vacuum and to transfer them from the magazine to another location for further processing. Such a device is known, for example, from the document DD 160106 A1. This prior art, however, provides that individual labels are withdrawn from a magazine via a withdrawal unit and are subsequently transferred to a transfer unit. The respective label is then in turn handed over from the transfer unit to a gripper cylinder. Altogether, this prior art exhibits a mechanically relatively complex solution which is not suited for high throughputs, in particular in the beverage industry.

Moreover, it was already contemplated in prior art to use labels which do not have to be prepared by the application of glue after their withdrawal from the magazine to be applied onto the object to be labeled, but which are already provided with an activatable adhesive coating. The document DE 10243704 A1, for example, describes a labeling machine in which the labels can be used with a thermo-activatable coating. By thermal irradiation, this coating is brought into an adhesive state, so that the label can be applied onto the object to be labeled, that means onto the container.

Document DE 29924839 A1 also describes a comparable device, where it additionally arises from this document that the activation can also be effected by moistening.

Unfortunately, such labels have not yet become accepted as they are difficult to handle. The reason for this is that meanwhile, ever higher demands are put on labeling, for example of bottles. Labels must be exactly positioned on the bottle so that the bottle has an attractive appearance in the sales shelf. Furthermore, the labels must sufficiently adhere to the labeled object, for example if it is stored in ice water for a relatively long time for cooling. All these demands could not yet be reliably met with labels to be glued with conventional wet glue. Moreover, with beverages, packs with different surface temperatures are labeled, so that in particular in case of cold filling, a high amount of condensation water is formed which can affect the labeling quality.

Finally, the document DE 102006021056 A1 also describes a device in which individual activatable labels are withdrawn from a label magazine via a withdrawal pallet, this withdrawal pallet being provided with an adhesive coating. The disadvantage of this device is that the adhesive coating tends to soiling and therefore has to be cleaned regularly to ensure a reliable withdrawal of labels from the magazine.

Further prior art is known from WO 2009024357 A1. This citation discloses a device for labeling objects, in particular liquid containers, with labels which are provided with a fixing side activatable by moistening, wherein the device is designed with a label provision means for providing individual labels, a label acceptance means for accepting and transferring at least one label provided by the label provision means, a transfer rotor which takes the label from the label acceptance means and applies it onto a surface of the object to be labeled, a conditioning unit for determining the current state of the surface of the object to be labeled, and an activation unit for moistening the label, wherein the activation unit activates the label taken from the transfer rotor by moistening, wherein the degree of moistening is adjustable according to the state of the surface of the object to be labeled currently determined by the conditioning unit.

This device, however, has the disadvantage that, although the subject was highly topical in the 80's, practically no high-performance application has ever been evidenced. Furthermore, none of the above listed methods is suited for conically shaped containers, or only suited within limits. In particular if the label length/label width is 180 mm or greater. The problem is also aggravated if form labels, in particular wrap-around labels, are to be used for cups.

### SUMMARY OF THE DISCLOSURE

It is an aspect of the present disclosure to provide a device which eliminates the above-described defects, to provide a secure labeling device in particular for conically shaped cups with form labels which should be sufficiently sturdy and clean.

More specifically, the disclosed device is a labeling machine for conical containers with a container's axis of rotation, with a container directing device embodied for moving the containers, with a label transfer means adjacent to the container directing device and with a label magazine embodied for dispensing labels to a label transfer means acting between the containers and the label magazine. The labeling machine includes a transfer mechanism having at least one rotating transfer cylinder rotating about a first axis of rotation, and this first axis of rotation being inclined relative to the container's axis of rotation, and wherein the label transfer means also includes a transport pallet mechanism rotatable about a second axis of rotation and designed for withdrawing labels from the label magazine using vacuum.

According to the disclosure, the above aspect is provided by at least one glue sprayer embodied for dispensing glue cooperating with a label located on a transfer cylinder embodied as vacuum cylinder such that a final gluing and/or an initial gluing is applied onto the label. Final gluing here means gluing in the region of the section of the label that comes into contact with the container last. Initial gluing here means gluing in the region of the section of the label that comes into contact with the container first. This region can also be located in the center of the label. This is the case with a so-called centric transfer. In a so-called lateral transfer, initial gluing is at the one end of the label, and final gluing is at the other end of the label. A particularly clean transfer of the labels from the label magazine to the respective container becomes possible.

The container's axis of rotation is here defined as a longitudinal axis of the container acting as axis of symmetry.

In such an embodiment, it becomes possible to position the labels exactly on the container, to have relatively low glue consumption, to enforce high efficiency, and all this while high throughputs are permitted. Moreover, the labels can be easily handled and have an attractive appearance in the sales shelf. Furthermore, soiling due to adhesion is prevented. Moreover, a label length/label width of more than 218 mm and even more than 260 mm can be used.

It is furthermore advantageous to use a plurality of transfer cylinders in the transfer mechanism to increase the throughput of the labeling machine.

Another advantage is achieved if there are two glue sprayers, one of them being designed for applying the initial gluing on the label, and the other one being designed for applying the final gluing on the label. In such an embodiment, the two glue sprayers apply at least two strips of glue onto the label, the label abutting against the transfer cylinder in the state of the application of the glue. However, it is also possible that between the initial gluing and the final gluing, further glue strips are applied if this is desired.

As an alternative, it is also possible that one glue sprayer is present which is provided for dispensing glue to a container for providing the initial gluing. In this case, the initial gluing is not applied onto the label but directly onto the container. If the container comes into contact with the label with this initial gluing, the label is detached from the transfer cylinder and subsequently applied onto the container, the flush labeling being ensured by the presence of the final gluing at the label.

If the transfer mechanism also comprises one gripper each per transfer cylinder, transport security is increased.

Transfer cylinders are defined as closed cylinder systems as well as open cylinder systems. Open cylinder systems can be, for example, pallet-like structures which are well known from labeling technology. Transfer cylinders of other designs are also conceivable.

The process is improved if the gripper is arranged such that it can be brought to an abutment with the label in the region of the latter coming first into contact with the container.

It is moreover advantageous if a press-on station or a brush-on station is arranged downstream of the transfer mechanism, seen in the container's conveying direction. The bonding between the label and the container is then improved.

If the brush-on station comprises a brush plate and/or a plurality of brushes and/or a sponge plate, the good bonding between the label and the container can be achieved utilizing efficient and inexpensive auxiliary means.

It is furthermore advantageous if the container directing device is embodied as a belt table or servo bottle table.

It is moreover advantageous for the glue to be hot glue.

Another advantageous embodiment is characterized in that the labeling machine is embodied for a wrap-around labeling of a container.

### BRIEF DESCRIPTION OF THE DRAWINGS

The disclosure will be illustrated more in detail below with reference to a drawing.

In the drawings:

FIG. 1 shows a detail of a labeling machine in a schematic representation,

FIG. 2 shows a section through the labeling machine in the region of the transfer mechanism, and

FIG. 3 shows a view onto a label for the conical containers, wherein different types of gluing, in particular the initial gluing and the final gluing, are represented.

### DETAILED DESCRIPTION OF THE PREFERRED EMBODIMENT

The figures only serve the understanding of the disclosure. For the same elements, the same reference numerals are used.

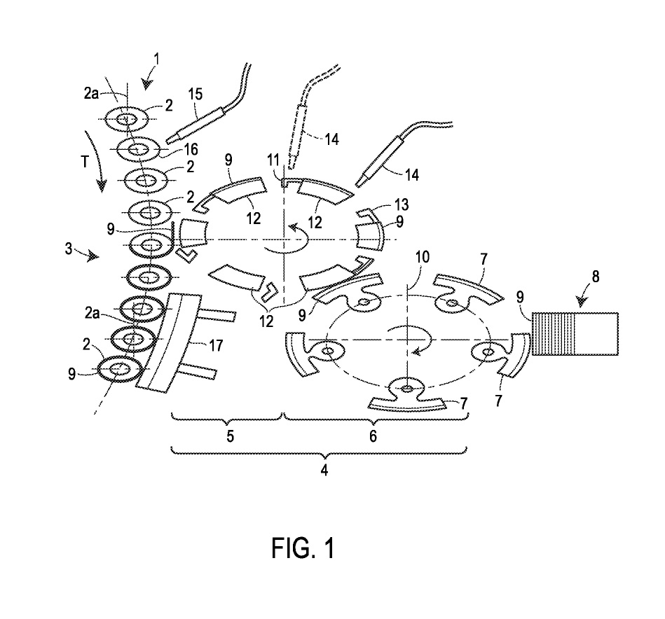

FIG. 1 shows a detail of a labeling machine 1 according to the disclosure. In the labeling machine 1, conical containers 2 are transported in a container directing device 3 in the direction of a conveying direction T. The containers 2 are preferably embodied to be symmetrical to their container's axis of rotation 2a. The conveying direction can also be referred to as transport direction. A label transfer means is provided adjacent to the container directing device. This label transfer means has the reference numeral 4.

The label transfer means comprises two different mechanisms. On the one hand, it comprises a transfer mechanism 5, and on the other hand a transport pallet mechanism 6.

The transport pallet mechanism 6 comprises individual transport pallets 7 which can in particular be embodied as vacuum transport pallets. The transport pallets 7 withdraw labels 9 stored in a label magazine 8.

The transport pallets 7 rotate clockwise about an axis designated as second axis of rotation 10. The labels 9 are conveyed to the transfer mechanism 5 and forwarded there to a transfer cylinder 12 rotating about an axis referred to as first axis of rotation 11. The transfer cylinders 12 can be embodied as vacuum cylinders. Here, a gripper 13 is in correlation with each transfer cylinder. The gripper 13 secures the labels 9 on the surface of the transfer cylinders 12 and/or initiates the transfer process of the labels 9 onto and/or from the transfer cylinders 12.

The surface of the labels 9 now facing outwards for being placed against the containers 2 is provided with a final gluing 18 by a glue sprayer 14. This glue sprayer 14 can in addition or as an alternative also apply an initial gluing 16.

However, in the here represented embodiment, a further glue sprayer 15 is employed to directly apply the initial gluing 16 onto the surface of the container 2.

As soon as the end of the label 9 closest to the container 2 is sufficiently close to the container 2 due to the rotation by the transfer cylinder 12 about the first axis of rotation 11, the gripper 13 folds away and releases this end. The end then comes to an abutment with the initial gluing 16 on the container 2.

By the container 2 also rotating itself, namely about a container's axis of rotation 2a, now at least from this point in time on, the complete label rolls onto the surface of the container 2 and follows its conical structure. Rolling off is supported in a press-on station 17. Instead of the press-on station or in addition to it, a brush-on station can also be employed.

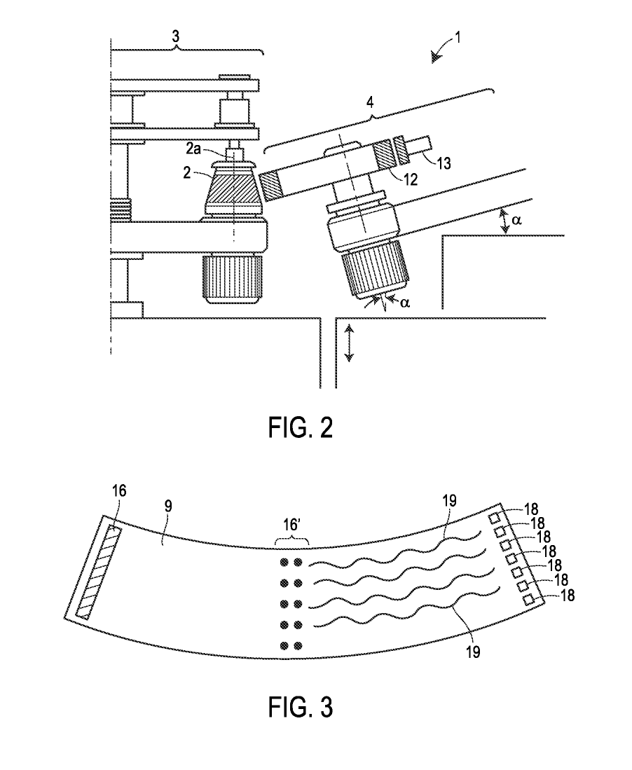

One can see in FIG. 2 that the module unit comprising the transfer mechanism 5 is inclined. This inclination is visualized by the angle α.

In FIG. 3, the initial gluing 16 as well as the interrupted final gluing 18 is represented.

The initial gluing 16 as well as the final gluing 18 can be designed to be continuous or interrupted. With a centric transfer, the initial gluing 16 is also arranged in the center of the label 9, as is indicated with the gluing 16′. Individual gluing traces 19 are also conceivable between the initial gluing 16 and the final gluing 18, if this is desired. Here, individual traces or paths of glue are applied onto the label.

1. A labeling machine for conical containers, comprising a container directing device which is embodied for moving the containers, a label transfer means adjacent to the container directing device and a label magazine which is embodied for dispensing labels to the label transfer means acting between the containers and the label magazine, wherein the label transfer means comprises a transfer mechanism which comprises at least one transfer cylinder rotating about a first axis of rotation, where the first axis of rotation is inclined relative to an axis of rotation of a container to be labeled by said labeling machine, wherein the label transfer means also comprises a transport pallet mechanism rotatable about a second axis of rotation which is designed for withdrawing labels from the label magazine, and at least one glue sprayer embodied for dispensing glue cooperates with a label located on a transfer cylinder, whereby one of a final gluing, an initial gluing, and a combination thereof is applied onto the label.

2. The labeling machine according to claim 1, wherein two glue sprayers are provided, one of the two glue sprayers is designed for applying the initial gluing onto the label, and the other of the two glue sprayers is designed for applying the final gluing onto the label.

3. The labeling machine according to claim 1, wherein a glue sprayer is provided for dispensing glue to a container for forming the initial gluing.

4. The labeling machine according to claim 1, wherein the transfer mechanism also comprises one gripper each per transfer cylinder.

5. The labeling machine according to claim 4, wherein the gripper is arranged such that it can be brought to an abutment with the label in the region of the latter which first comes into contact with the container.

6. The labeling machine according to claim 1, wherein one of a press-on station and a brush-on station is arranged downstream of the transfer mechanism, seen in the conveying direction (T) of the container.

7. The labeling machine according to claim 6, wherein the brush-on station comprises a brush plate, a plurality of brushes, a sponge plate, and a combination thereof.

8. The labeling machine according to claim 1, wherein the container directing device is embodied as one of a belt table and a servo bottle table.

9. The labeling machine according to claim 1, wherein the transport pallet mechanisms utilizes a vacuum.

10. The labeling machine according to claim 1, wherein the transfer cylinder is a vacuum cylinder.
